(19) United States
(12) Patent Application Publication
(10) Pub. No.: US 2008/0060904 A1
(43) Pub. Date: Mar. 13, 2008

(54) Support structure of a friction apply device and transmission

(75) Inventor: Takanori Nukata, Toyota-shi (JP)

Correspondence Address: KENYON & KENYON LLP, 1500 K STREET N.W., SUITE 700, WASHINGTON, DC, 20005, US

(73) Assignee: Toyota Jidosha Kabushiki Kaisha

(21) Appl. No.: 11/896,858

(22) Filed: Sep. 6, 2007

(30) Foreign Application Priority Data
Sep. 8, 2006 (JP) 2006-244350

(51) Int. Cl. F16D 25/0638

(52) U.S. Cl. 192/106 R

(57) ABSTRACT

A support structure of a brake includes a snap ring, friction plates, a back plate, and return springs. The snap ring is arranged in a groove that extends in a circle around a predetermined axis. The return springs push the back plate against the snap ring. The snap ring includes a pair of abutments that face one another across a gap in the circumferential direction. The return spring is arranged within a range of +90° with respect to the center of the gap between the pair of abutments around the predetermined axis. The return spring is arranged within a range of −90° with respect to the center of the gap between the pair of abutments around the predetermined axis.

### INCORPORATION BY REFERENCE

The disclosure of Japanese Patent Application No. 2006-244350 filed on Sep. 8, 2006 including the specification, drawings and abstract is incorporated herein by reference in its entirety.

### BACKGROUND OF THE INVENTION

1. Field of the Invention

The invention generally relates to a support structure of a friction apply device, and a transmission. More particularly, the invention relates to a support structure of a friction apply device that has a snap ring which restricts the movement of friction plates in the axial direction, and a transmission provided with this support structure of a friction apply device.

2. Description of the Related Art

Regarding a related support structure for a friction apply device, Japanese Patent Application Publication No. JP-A-2001-193756, for example, describes an overlap clutch assembly for an automatic transmission which is effective for improving the control accuracy when shifting from a neutral position into a reverse position and aims to reduce the overall length of the clutch assembly (i.e., make the clutch assembly more compact). The clutch assembly described in Japanese Patent Application Publication No. JP-A-2001-193756 includes a clutch plate and clutch disc, a piston that moves forward by hydraulic pressure thus frictionally engaging the clutch plate with the clutch disc, a stopper plate arranged on the opposite side of the clutch plate and the clutch disc from the piston, and a return spring which is arranged between the stopper plate and the piston and returns the piston to its original position when the clutch is released.

In the clutch assembly described in Japanese Patent Application Publication No. JP-A-2001-193756, a snap ring is used to restrict the movement of the friction plates to which hydraulic pressure is applied. However, because the snap ring is not completely ring-shaped but rather shaped like the letter C in which a portion of the ring shape has been cut, the snap ring is less rigid at the abutment portions where the cut was made. As a result, there is a gap between the snap ring and the bottom surface of the groove into which the snap ring is fitted at the area near the abutments. On the other hand, when the hydraulic pressure applied to the friction plates is repeatedly applied to the snap ring, it may cause the snap ring to move toward the outside of the groove. In this case, sufficient catching allowance between the snap ring and the groove (i.e., the allowance by which the snap ring catches in the groove so that the snap ring will not slip out of the groove) may not be able to be obtained.

### SUMMARY OF THE INVENTION

This invention thus provides a support structure of a friction apply device in which sufficient catching allowance between a snap ring and a groove can be obtained along the entire periphery, and a transmission.

A first aspect of the invention relates to a support structure of a friction apply device, which includes a snap ring, friction plates, a plate member, and first and second elastic members. The snap ring is arranged in a groove that extends in a circle around a predetermined axis. The snap ring restricts the movement of the friction plates in the axial direction. The friction plates engage by friction when pressed in the axial direction toward the snap ring. The plate member is arranged between the friction plates and the snap ring. The first and second elastic members push the plate member against the snap ring. The snap ring includes a pair of abutments that face one another across a gap in the circumferential direction. The first elastic member is arranged within a range of +90° with respect to the center of the gap around the axis. The second elastic member is arranged within a range of −90° with respect to the center of the gap around the axis.

According to this first aspect, the rigidity of the snap ring is relatively low at the phase on the side where the gap is formed and relatively high at the phase on the side opposite the side where the gap is formed. According to the characteristics of this kind of snap ring, when the snap ring is arranged in the groove, a gap between the snap ring and the bottom surface of the groove is formed adjacent to one of the two abutments and a gap between the snap ring and the bottom surface of the groove is formed adjacent to the other of the two abutments. The sizes of these gaps are greatest within a range of ±90° with respect to the center of the gap.

With respect to this, in the first aspect, the first and second elastic members are arranged within a range of ±90° with respect to the center of the gap. That is, the first and second elastic members are arranged such that their elastic forces are largely applied by the plate member at phases where the gaps between the snap ring and the bottom surface of the groove are greatest. As a result, when force that applies pressure to the friction plates causes the plate member to behave in the direction opposite the direction in which the snap ring would slip out of the groove, a large amount of frictional force can be generated between the friction member and the snap ring at the phases where the gaps between the snap ring and the bottom surface of the groove are greatest. Accordingly, with this behavior of the plate member, the snap ring can be moved in the direction opposite the direction in which the snap ring would slip out of the groove. As a result, sufficient catching allowance between the snap ring and the groove can be ensured along the entire periphery around the axis.

In the foregoing first aspect, the first elastic member may be arranged within a range from +30° to +60°, inclusive, with respect to the center of the gap around the axis, and the second elastic member may be arranged within a range from −30° to −60°, inclusive, with respect to the center of the gap around the axis. Furthermore, the first elastic member may apply pressure to the snap ring at a position of +45° with respect to the center of the gap around the axis, and the second elastic member may apply pressure to the snap ring at a position of −45° with respect to the center of the gap around the axis. Also, the first elastic member and the second elastic member may be arranged axisymmetrical with respect to a straight line that connects the center of the gap with the center of the snap ring. Moreover, a third elastic member that applies pressure to the snap ring may also be provided in addition to the first and second elastic members, and this third elastic member may be arranged within a range from +150° to +210°, inclusive, or at a position of +180° with respect to the center of the gap around the axis. The first, second, and third elastic members may be arranged at equidistant intervals around the center axis of the snap ring.

A second aspect of the invention relates to a support structure of a friction apply device, which includes a snap ring, friction plates, a plate member, and first and second elastic members. The snap ring is arranged in a groove that extends in a circle around a predetermined axis. The snap ring restricts the movement of the friction plates in the axial direction. The friction plates engage by friction when pressed in the axial direction toward the snap ring. The plate member is arranged between the friction plates and the snap ring. The first and second elastic members push the plate member against the snap ring. The snap ring includes a pair of abutments that face one another across a gap in the circumferential direction. A first gap between the snap ring and the bottom surface of the groove is formed adjacent to one of the two abutments, and a second gap between the snap ring and the bottom surface of the groove is formed adjacent to the other of the two abutments. The first elastic member is arranged at a phase where the first gap is greatest around the axis, and the second elastic member is arranged at a phase where the second gap is greatest around the axis.

According to this second aspect, the elastic forces from the first and second elastic members are largely applied by the plate member at phases where the gaps between the snap ring and the bottom surface of the groove are greatest. As a result, when force that applies pressure to the friction plates causes the plate member to behave in the direction opposite the direction in which the snap ring would slip out of the groove, a large amount of frictional force can be generated between the friction member and the snap ring at the phases where the gaps between the snap ring and the bottom surface of the groove are greatest. Accordingly, with this behavior of the plate member, the snap ring can be moved in the direction opposite the direction in which the snap ring would slip out of the groove. As a result, sufficient catching allowance between the snap ring and the groove can be ensured along the entire periphery around the axis.

Furthermore, the support structure of a friction apply device in the first or second aspect may also include a piston member which is arranged on the opposite side of the friction plates from the plate member and applies pressure to the friction plates by moving in a direction toward the plate member. Also, the first elastic member and the second elastic member may be arranged between the piston member and the plate member and urge the piston member in a direction away from the plate member. According to the support structure of a friction apply device having this kind of structure, any of the effects described above can be achieved in a friction apply device that releases applied friction plates by the elastic force of the first and second elastic members.

A third aspect of the invention relates to a transmission provided with the support structure of a friction apply device of the first or second aspect. With a transmission having this kind of structure, the reliability of the transmission can be improved by ensuring operation of the friction apply device.

The first to the third aspects make it possible to provide both a support structure of a friction apply device in which sufficient catching allowance between the snap ring and the groove can be obtained along the entire periphery, and a transmission.

### BRIEF DESCRIPTION OF THE DRAWINGS

The foregoing and further objects, features and advantages of the invention will become apparent from the following description of preferred embodiments with reference to the accompanying drawings, wherein like numerals are used to represent like elements and wherein:

FIG. 1 is a sectional view of an automatic transmission mounted in a vehicle;

FIG. 2 is a sectional view of a support structure of a brake according to an example embodiment of the invention;

FIG. 3 is a perspective view of a back plate shown in FIG. 2;

FIG. 4 is a view of a snap ring shown in FIG. 2;

FIG. 5 is a view illustrating the positions in which return springs shown in FIG. 2 are arranged;

FIG. 6 is a view of a support structure of a brake for comparison;

FIG. 7 is a sectional view showing the states of the snap ring initially, during application of a hydraulic pressure load, and after the hydraulic pressure load has been released in the support structure of a brake for comparison shown in FIG. 6;

FIG. 8 is a sectional view showing the states of the snap ring initially, during application of a hydraulic pressure load, and after the hydraulic pressure load has been released that are shown in FIG. 7 superposed on one another;

FIG. 9 is a sectional view showing the states of the snap ring initially, during application of a hydraulic pressure load, and after the hydraulic pressure load has been released in the support structure of a brake shown in FIG. 2;

FIG. 10 is a sectional view showing the states of the snap ring initially, during application of a hydraulic pressure load, and after the hydraulic pressure load has been released that are shown in FIG. 9 superposed on one another;

FIG. 11 is a sectional view showing the force applied to the snap ring during application of a hydraulic pressure load shown in FIG. 9;

FIG. 12 is a graph showing the relationship between a coordinate value θ and a coordinate value R in the support structure of a brake shown in FIG. 2; and

FIG. 13 is a graph showing the relationship between the coordinate value θ and the coordinate value R in the support structure of a brake for comparison shown in FIG. 6.

### DETAILED DESCRIPTION OF THE PREFERRED EMBODIMENTS

Example embodiments of the invention will now be described with reference to the accompanying drawings. Like or corresponding members in the drawings will be denoted by the same reference numerals.

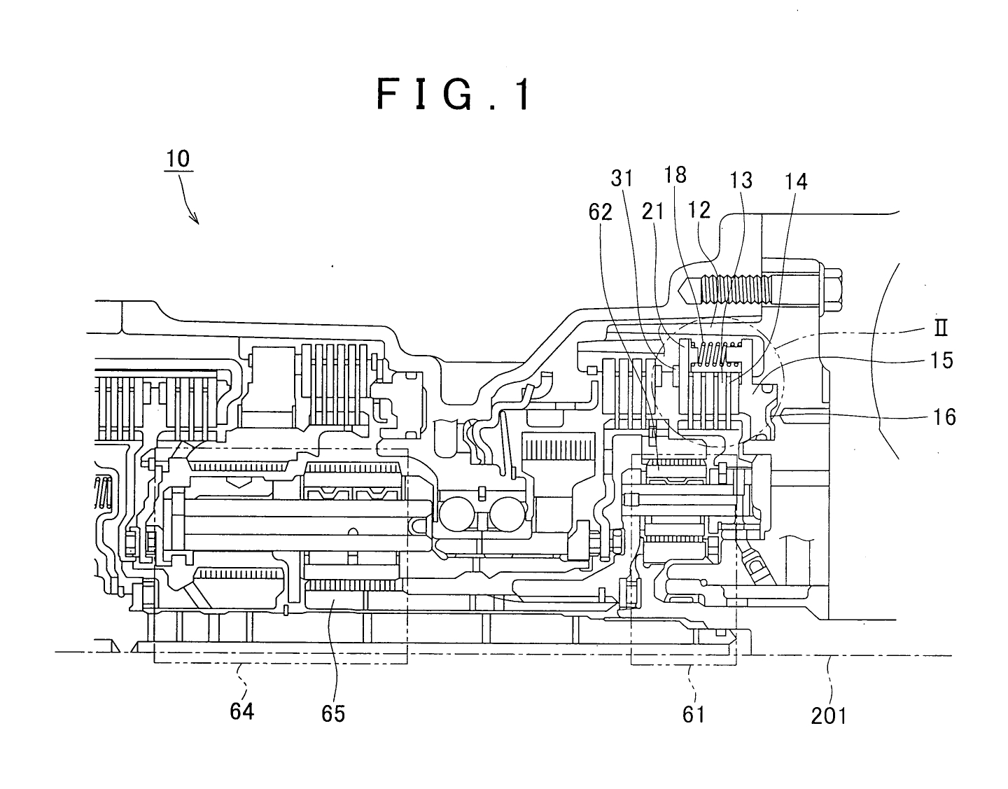

FIG. 1 is a sectional view of an automatic transmission mounted in a vehicle. In the drawing, only a portion of the automatic transmission is shown. Referring to FIG. 1, an automatic transmission 10 includes a plurality of planetary gear sets, i.e., a UD (underdrive) planetary gear set 61 and a Ravigneaux type planetary gear set 64. With the combination of these two planetary gear sets, i.e., the UD planetary gear set 61 and the Ravigneaux type planetary gear set 64, the automatic transmission 10 can accelerate or decelerate rotation input from an internal combustion engine and output the resultant rotation either in the forward direction or in the reverse direction. The UD planetary gear set 61 is housed in a case body 12.

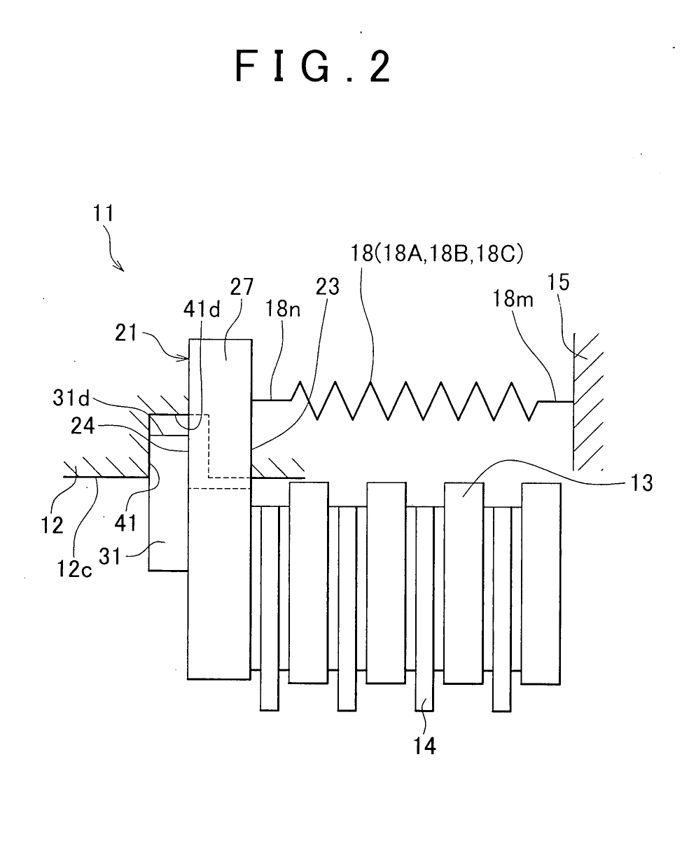

FIG. 2 is a sectional view of a support structure of a brake according to this example embodiment of the invention. The portion shown in FIG. 2 is the portion that is encircled by the alternate long and two short dashes line II in FIG. 1.

Referring to FIGS. 1 and 2, the automatic transmission 10 includes a brake 11 which is a friction apply device. The brake 11 locks a planetary carrier 62 of the UD planetary gear set 61 and a sun gear 65 of the Ravigneaux type planetary gear set 64 against rotation. The brake 11 includes a plurality of friction plates 13, a plurality of friction plates 14, a back plate 21, a snap ring 31, and a plurality of return springs 18 (i.e., 18A, 18B, and 18C), all housed in the case body 12.

The case body 12 includes an inner peripheral surface 12c that extends around a center axis 201 which is a virtual axis. This center axis 201 is the rotational center of the UD planetary gear set 61 and the Ravigneaux type planetary gear set 64.

The friction plates 13 are fixed to the case body 12. The friction plates 14 are fixed to the planetary gear side (for example, to the outer peripheral surface of a ring gear of the planetary gear set). The friction plates 13 and the friction plates 14 are fixed to the case body 12 and the planetary gear side, respectively, so as to be able to move in the axial direction of the center axis 201 but not able to rotate in the circumferential direction around the center axis 201. The friction plates 13 and 14 are ring-shaped and extend in a circle to the inside of the inner peripheral surface 12c. The friction plates 13 and the friction plates 14 are arranged side by side alternately in the axial direction of the center axis 201.

The brake 11 also includes a brake piston 15. This brake piston 15 is arranged adjacent to the friction plates 13 and 14 in the axial direction of the center axis 201. A hydraulic pressure chamber 16 is formed inside the case body 12. This hydraulic pressure chamber 16 is formed adjacent to the brake piston 15 in the axial direction of the center axis 201. The brake piston 15 is arranged between the hydraulic pressure chamber 16 and the friction plates 13 and 14.

When hydraulic pressure is supplied to the hydraulic pressure chamber 16 (i.e. when a hydraulic pressure load is applied), the brake piston 15 moves in the axial direction of the center axis 201 and applies pressure to the friction plates 13 and 14. When pressure is applied to the friction plates 13 and 14, they engage with each other by friction. As a result, the friction plates 13 and the friction plates 14 become applied (i.e., engaged), thereby locking the planetary carrier 62 and the sun gear 65 against rotation.

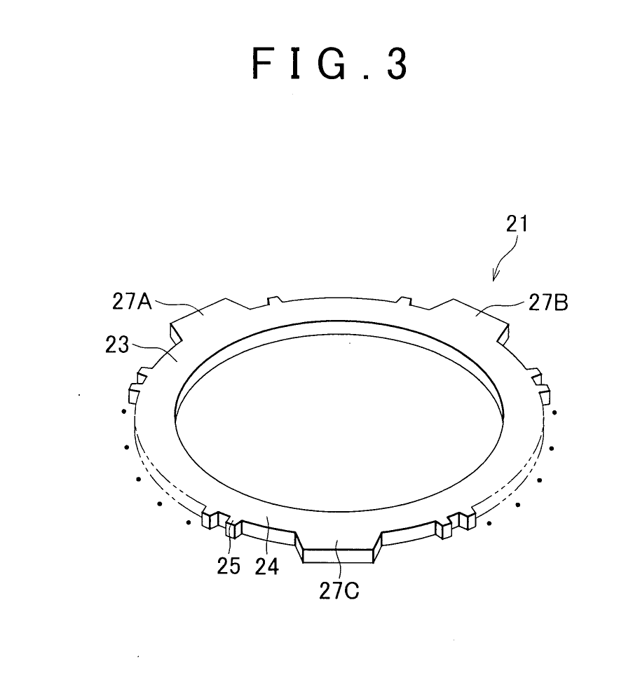

FIG. 3 is a perspective view of the back plate 21 shown in FIG. 2. Referring to FIGS. 2 and 3, the back plate 21 is made of metal and arranged between the snap ring 31 and the friction plates 13 and 14. The snap ring 31, the back plate 21, and the friction plates 13 and 14 are arranged stacked in the axial direction of the center axis 201. The back plate 21 is fixed to the case body 12.

The back plate 21 has a ring shape and extends in a circle around the center axis 201. The back plate 21 includes an end face 23 and an end face 24 which face in opposite directions in the axial direction of the center axis 201 and extend in a circle around the center axis 201. The end face 23 faces the friction plates 13 and 14, while the end face 24 faces the snap ring 31. The end faces 23 and 24 extend within a plane that lies orthogonal to the center axis 201.

The back plate 21 includes splines 25. These splines 25 engage with splines, not shown, formed on the inner peripheral surface 12c of the case body 12, thereby fixing the back plate 21 to the case body 12 in a manner such that the back plate 21 is able to move in the axial direction of the center axis 201 but will not rotate in the circumferential direction around the center axis 201. The back plate 21 includes a plurality of flange portions 27 (i.e., 27A, 27B, and 27C). These flange portions 27 extend in the radial direction around the center axis 201. In this example embodiment, these flange portions 27 extend to the outside in the radial direction around the center axis 201. The plurality of these flange portions 27 are formed at intervals in the circumferential direction around the center axis 201.

Each return spring 18 extends in the axial direction of the center axis 201 and includes one end 18m that is connected to the brake piston 15 and another end 18n that is connected to a flange portion 27 of the back plate 21. The return spring 18A corresponds to the flange portion 27A, the return spring 18B corresponds to the flange portion 27B, and the return spring 18C corresponds to the flange portion 27C. The plurality of return springs 18 are arranged at equidistant intervals around the center axis 201.

The snap ring 31 is positioned between the return springs 18 and the friction plates 13 and 14 in the radial direction around the center axis 201. Elastic force from the return springs 18 urges the brake piston 15 away from the back plate 21 in the axial direction of the center axis 201 and pushes the back plate 21 against the snap spring 31.

When hydraulic pressure stops being supplied to the hydraulic pressure chamber 16 (i.e. when the hydraulic pressure load has been released), the elastic force from the return springs 18 pushes the brake piston 15 away from the back plate 21. As a result, the friction plates 13 and the friction plates 14 release (i.e., disengage), thereby allowing the planetary carrier 62 and the sun gear 65 to rotate.

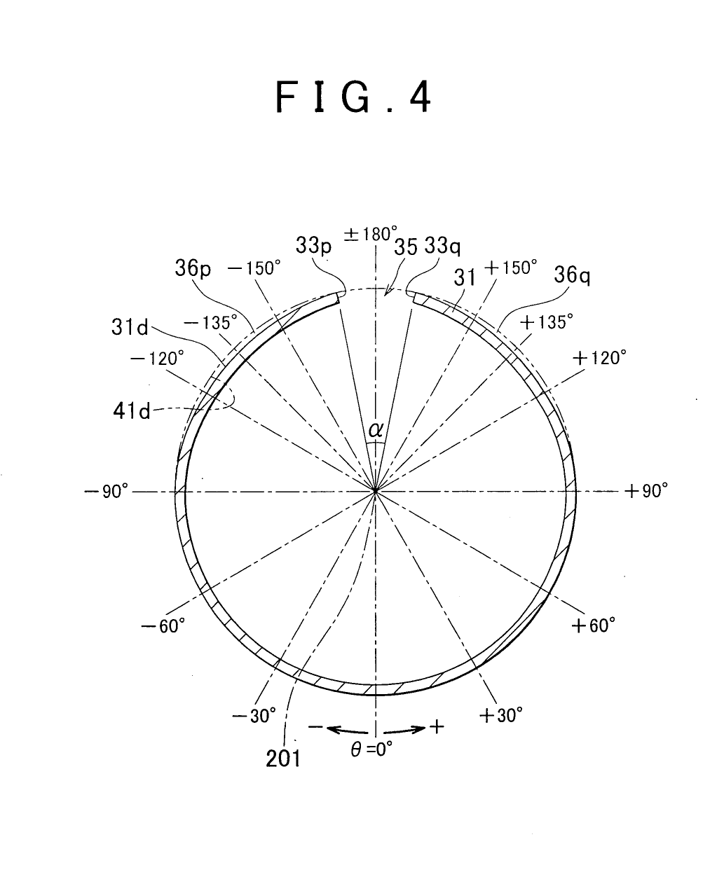

FIG. 4 is a view of the snap ring shown in FIG. 2. In the drawing, the snap ring is shown as viewed from the axial direction of the center axis 201 in FIG. 1.

Referring to FIGS. 2 and 4, a groove 41 is formed in the inner peripheral surface 12c of the case body 12 and extends in a circle around the center axis 201. The groove 41 is perfectly circular around the center axis 201. This groove 41 has a generally rectangular cross-section and includes a bottom surface 41d. The snap ring 31 fits into the groove 41 and restricts the movement of the friction plates 13 and 14 in the axial direction of the center axis 201. The snap ring 31 restricts the movement of the friction plates 13 and 14 which are pressed against by the brake piston 15.

The snap ring 31 is made of metal and is shaped like the letter C with a portion in the circumferential direction that has been cut. The snap ring 31 includes a pair of abutments 33p and 33q. These abutments 33p and 33q face one another across a gap 35 in the circumferential direction around the center axis 201. In FIG. 4, the phase around the center axis 201 is indicated by a coordinate value θ. The phase at the center of the gap 35 is θ=±180° and the phase on the opposite side is θ=0°. θ=+180° is reached by traveling counterclockwise from θ=0° and θ=−180° is reached by traveling clockwise from θ=0°. The angle α between the abutment 33p and the abutment 33q is within a range greater than 0° and equal to or less than 30°, for example, or within a range greater than 0° and equal to or less than 45°, for example. In this example embodiment, the angle α between the abutment 33p and the abutment 33q is 22.5°.

The rigidity of the snap ring 31 is relatively low at the phase where the gap 35 is formed and relatively high at the phase on the opposite side. Accordingly, the force (i.e., the constricting force) with which the snap spring 31 that is fitted in the groove 41 presses against the bottom surface 41d of the groove 41 is relatively small at the phase of the upper half in FIG. 4 around θ=180°, and relatively large at the phase of the lower half in FIG. 4 around θ=0°.

According to these kinds of characteristics of the snap ring 31, when the snap ring 31 is fitted in the groove 41, the outer peripheral surface 31d of the snap ring 31 and the bottom surface 41d of the groove 41 fit closely at the abutments 33p and 33q, and at the phase on the opposite side of the phase where the gap 35 is formed. On the other hand, a gap 36p between the outer peripheral surface 31d and the bottom surface 41d is formed adjacent to the abutment 33p, while a gap 36q between the outer peripheral surface 31d and the bottom surface 41d is formed adjacent to the abutment 33q.

The size of the gap 36p is greatest within a range of 90° between θ=−180° and θ=−90°. In this example embodiment, the size of this gap 36p is greatest at θ=−135. The size of the gap 36q is greatest within a range of 90° between θ=+180° and θ=+90°. In this example embodiment, the size of the gap 36q is greatest at θ=+135°.

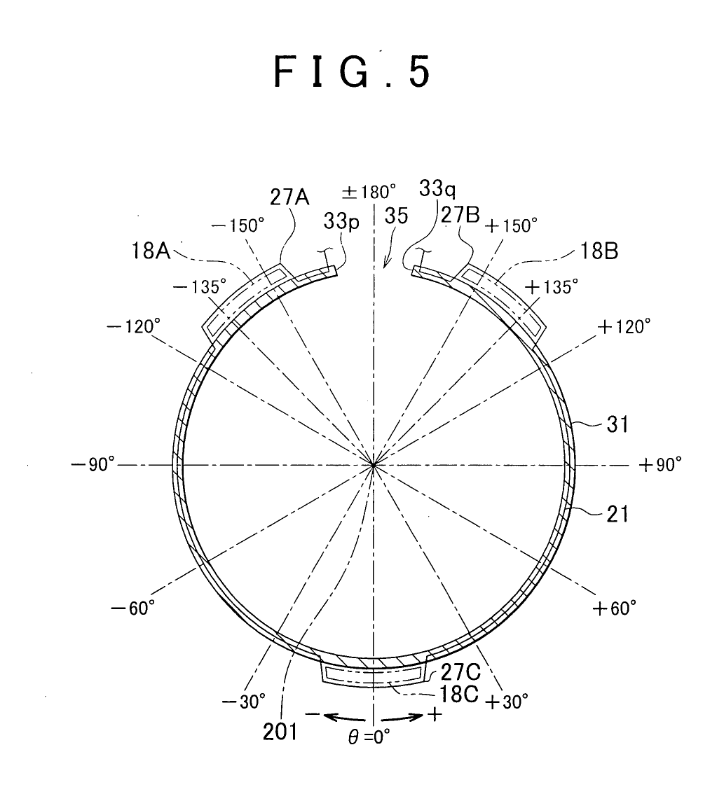

FIG. 5 is a view illustrating the positions in which the return springs shown in FIG. 2 are arranged. Referring to FIG. 5, the return spring 18A is arranged within a range of 90° between θ=−180° and θ=−90°. That is, the return spring 18A is arranged so that its position falls between θ=−180° and θ=−90°. This return spring 18A is arranged overlapping with θ=−135° where the size of the gap 36p between the outer peripheral surface 31d and the bottom surface 41d is greatest. The return spring 18B is arranged within a range of 90° between θ=+180° and θ=+90°. That is, the return spring 18B is arranged so that its position falls between θ=+180° and θ=+90°. This return spring 18B is arranged overlapping with θ=+135° where the size of the gap 36q between the outer peripheral surface 31d and the bottom surface 41d is greatest. The return spring 18C is arranged at θ=0°.

In this example embodiment, the plurality of return springs 18 are arranged so that they are axisymmetrical with respect to a straight line that connects θ=0° and θ=±180°. The invention is not limited to this kind of arrangement, however. For example, the return spring 18C may be arranged within a range from θ=0° to θ=−90°, inclusive.

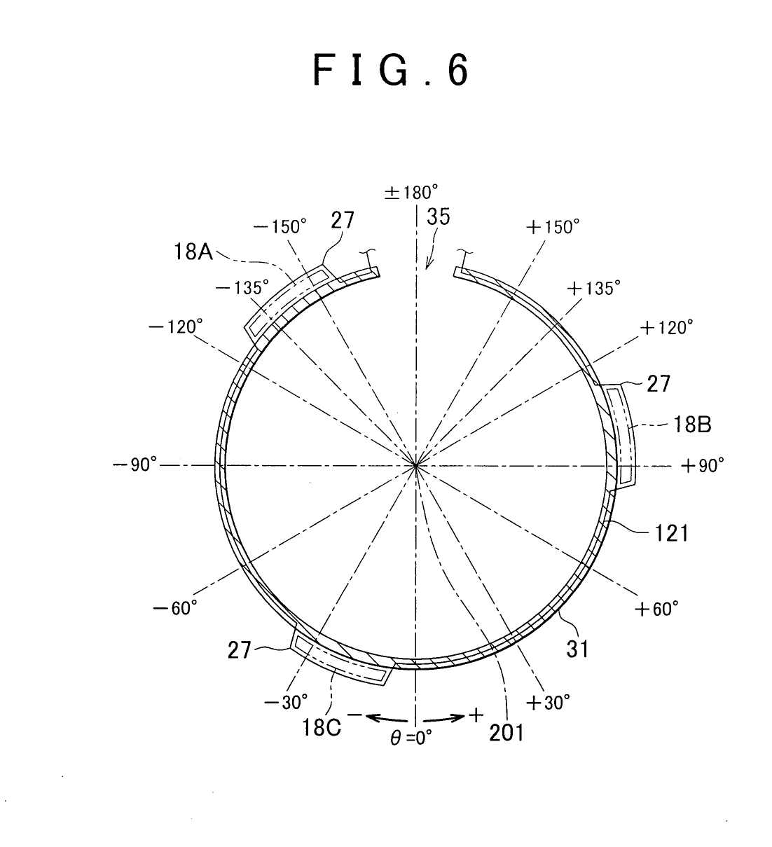

FIG. 6 is a view of a support structure of a brake for comparison, and corresponds to FIG. 5. Continuing on, the mechanism of a phenomenon in which the catching allowance between the snap ring 31 and the groove 41 decreases in the support structure of a brake for comparison shown in FIG. 6 will now be described.

Referring to FIG. 6, the support structure of a brake for comparison includes a back plate 121 in which the phases where the flange portions 27 are provided are different than those of the back plate 21 in FIG. 5. The return spring 18B is not arranged within a range of 90° between θ=+180° and θ=+90°, and is not arranged overlapping with θ=+135°. Instead, the return spring 18B is arranged at a phase that straddles θ=+90°.

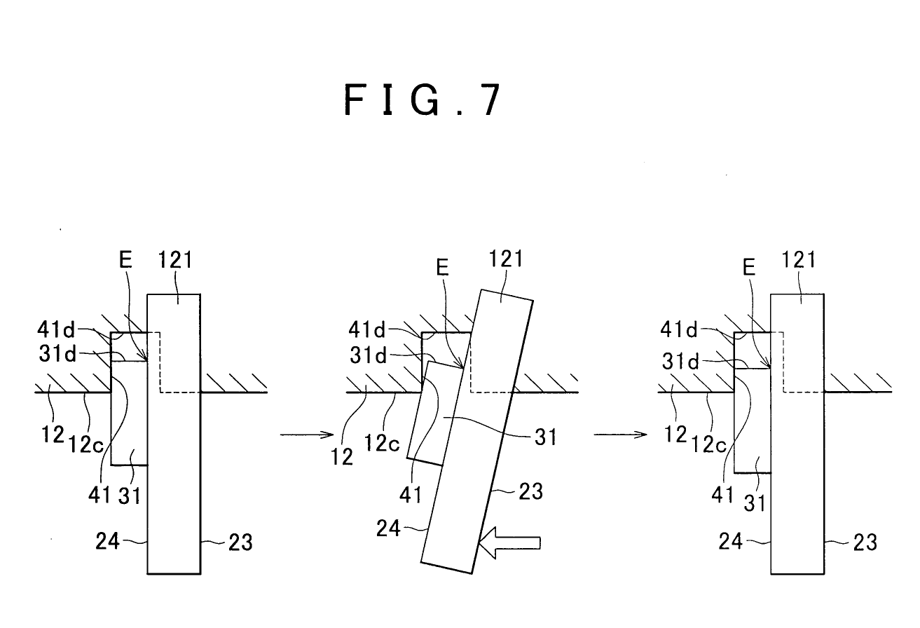

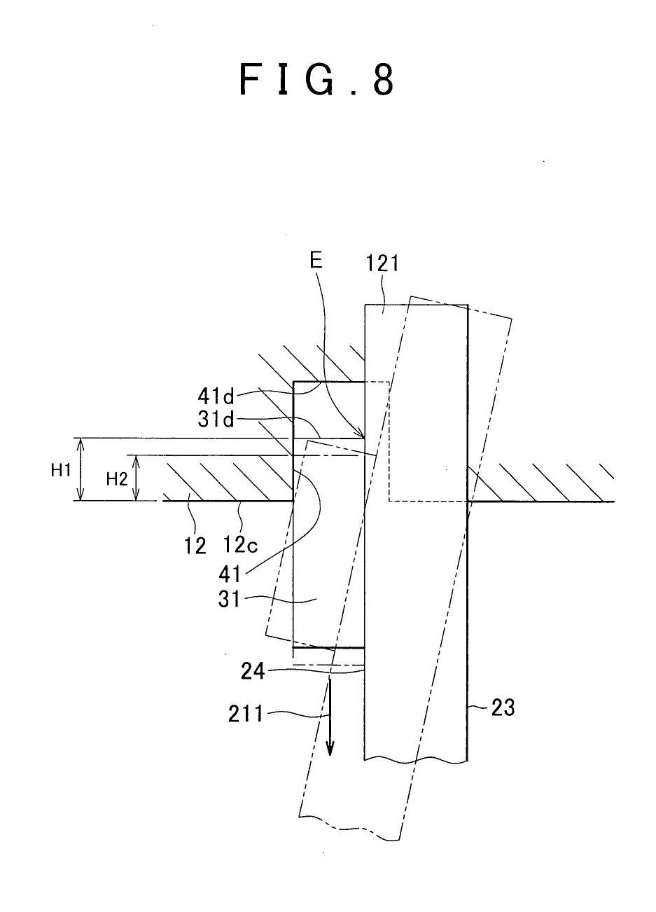

FIG. 7 is a sectional view showing the states of the snap ring initially (i.e., before hydraulic pressure is applied), during application of a hydraulic pressure load, and after the hydraulic pressure load has been released in the support structure of a brake for comparison shown in FIG. 6. FIG. 8 is a sectional view showing the states of the snap ring initially, during application of a hydraulic pressure load, and after the hydraulic pressure load has been released that are shown in FIG. 7 superposed on one another. These drawings show a cross-section of the snap ring 31 at θ=+135° in FIG. 6 where the gap 36q formed between the outer peripheral surface 31d of the snap ring 31 and the bottom surface 41d of the groove 41 is greatest.

Referring to FIGS. 7 and 8, the portion of the outer peripheral surface 31d that faces the back plate 121 will be referred to as corner portion E.

The catching allowance between the snap ring 31 and the groove 41 initially before a hydraulic pressure load is applied is H1. When a hydraulic pressure load is applied, force applied from the hydraulic pressure chamber 16 to the friction plates 13 and 14 is transmitted to the back plate 121 and the snap ring 31. At this time, the inner peripheral side of the back plate 121 that receives the force from the friction plates 13 and 14 angles into (i.e., inclines toward) the snap ring 31. The snap ring 31 then inclines together with the back plate 121 while the corner portion E slides on the surface of the back plate 121. As a result, the position of the corner portion E seems to become displaced in the radial direction around the center axis 201 in which the snap ring 31 would slip out of the groove 41 (hereinafter this radial direction will also referred to as the “rising direction of the snap ring 31” or simply “rising direction”), as shown by arrow 211 in FIG. 8.

After the hydraulic pressure load has been released, the back plate 121 returns from the position angled into the snap ring 31 to its original position. At this time, the snap ring 31 also returns to its original position together with the back plate 121, with the corner portion E fixed on the surface of the back plate 121 by the friction between the snap ring 31 and the back plate 121. As a result, the snap ring 31 is pulled in the rising direction when the hydraulic pressure load is released. After the hydraulic pressure has been released, the catching allowance between the snap ring 31 and the groove 41 is H2 which is smaller than H1. According to this kind of mechanism, a phenomenon occurs in which the catching allowance between the snap ring 31 and the groove 41 gradually decreases as the hydraulic pressure load is repeatedly applied and released.

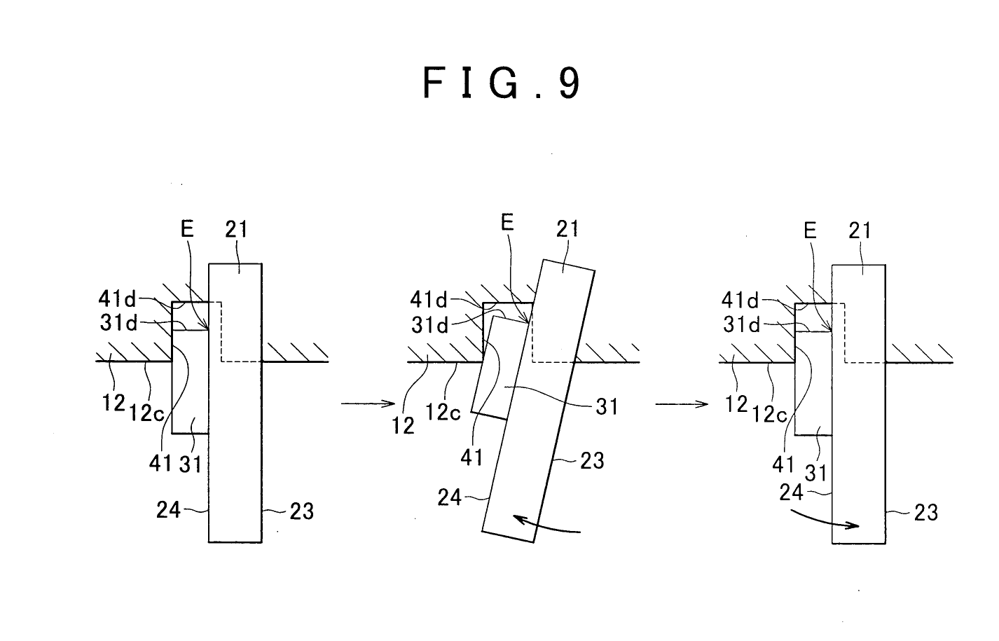

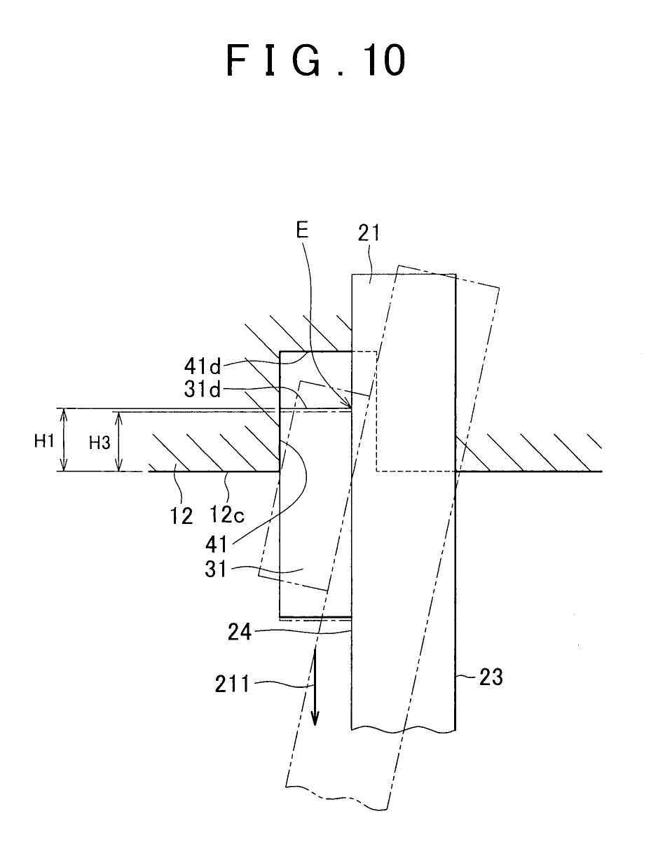

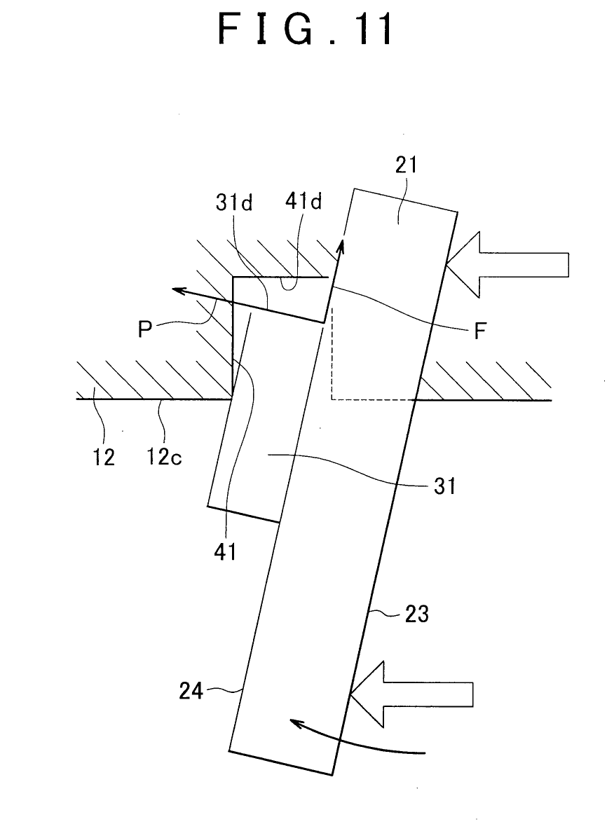

FIG. 9 is a sectional view showing the states of the snap ring initially, during application of a hydraulic pressure load, and after the hydraulic pressure load has been released in the support structure of the brake shown in FIG. 2. FIG. 10 is a sectional view showing the states of the snap ring initially, during application of a hydraulic pressure load, and after the hydraulic pressure load has been released that are shown in FIG. 9 superposed on one another. FIG. 11 is a sectional view showing the force applied to the snap ring during application of a hydraulic pressure load shown in FIG. 9. These drawings show a cross-section of the snap ring 31 at θ=±135° in FIG. 5 where the gaps 36q and 36q formed between the outer peripheral surface 31d of the snap ring 31 and the bottom surface 41d of the groove 41 are greatest.

Continuing on, the operation achieved by the support structure of the brake shown in FIG. 2 according to this example embodiment will now be described.

Referring to FIGS. 9 to 11, when a hydraulic pressure load is applied, the force applied from the hydraulic pressure chamber 16 to the friction plates 13 and 14 is transmitted to the back plate 21 and the snap ring 31 in the support structure of a brake according to this example embodiment as well. At this time, in this example embodiment, elastic force from the return springs 18 largely acts on the back plate 21 and the snap ring 31 at the phases where the gaps 36p and 36q between the outer peripheral surface 31d and the bottom surface 41d are greatest.

Accordingly, the reaction force P that the snap ring 31 receives from the back plate 21 increases, thereby increasing the frictional force F generated between the back plate 21 and the snap ring 31. When a hydraulic pressure load is being applied, the corner portion E is dragged by the back plate 21 and the snap ring 31 inclines together with the back plate 21. As a result, the snap ring 31 moves in the direction opposite the rising direction.

In this way, there is a difference in the behavior of the snap ring 31 during the application of a hydraulic pressure load between the support structure of a brake for comparison shown in FIG. 6 and the support structure of a brake according to this example embodiment. From this difference in behavior, with the support structure of a brake according to this example embodiment, the catching allowance between the snap ring 31 and the groove 41 after the hydraulic pressure load has been released becomes H3 which is larger than H2 in FIG. 8 of the support structure of a brake for comparison.

The support structure of the brake 11 which is the friction apply device in this example embodiment of the invention includes the snap ring 31, the friction plates 13 and 14, the back plate 21 which serves as a plate member, and the return springs 18A and 18B which serve as the first and second elastic members. The snap ring 31 is arranged in the groove 41 that extends in a circle around the center axis 201 which is a predetermined axis. The snap ring 31 restricts the movement of the friction plates 13 and 14 in the axial direction of the center axis 201. The friction plates 13 and 14 engage together by friction when pushed toward the snap ring 31 in the axial direction of the center axis 201. The back plate 21 is arranged between the snap ring 31 and the friction plates 13 and 14. The return springs 18A and 18B push the back plate 21 against the snap ring 31. The snap ring 31 includes a pair of abutments 33q and 33p which face each other across a gap 35 in the circumferential direction. The return spring 18A is arranged between θ=−180° and θ=−90°, i.e., within a range of −90° with respect to the center of the gap 35 around the center axis 201. The return spring 18B is arranged between θ=+180° and θ=+90°, i.e., within a range of +90° with respect to the center of the gap 35 around the center axis 201.

The gap 36q is formed as a first gap between the snap ring 31 and the bottom surface 41d of the groove 41, adjacent to the abutment 33q. The gap 36p is formed as a second gap between the snap ring 31 and the bottom surface 41d of the groove 41, adjacent to the abutment 33p. The return spring 18A is arranged at θ=−135° which is the phase where the gap 36p is greatest around the center axis 201. The return spring 18B is arranged at θ=+135° which is the phase where the gap 36q is greatest around the center axis 201.

According to the support structure of the brake 11 in this example embodiment of the invention, which is structured as described above, sufficient catching allowance between the snap ring 31 and the groove 41 is able to be ensured along the entire periphery around the center axis 201. As a result, operation of the planetary gear set by the brake 11 can be ensured which improves the reliability of the automatic transmission 10.

Continuing on, a test will now be described for checking the behavior of the snap ring 31 in the support structure of a brake shown in FIG. 2. In this test, the behavior of the corner portion E of the snap ring 31 initially (i.e., before application of the hydraulic pressure load), during application of the hydraulic pressure load, and after the hydraulic pressure load has been released was obtained by modeling the case body 12, the friction plates 13 and 14, the back plate 21, the snap ring 31, and the return springs 18 and the like of the support structure of a brake shown in FIG. 2 and then performing a CAE analysis. For comparison, the same analysis was performed on the support structure of a brake for comparison shown in FIG. 6.

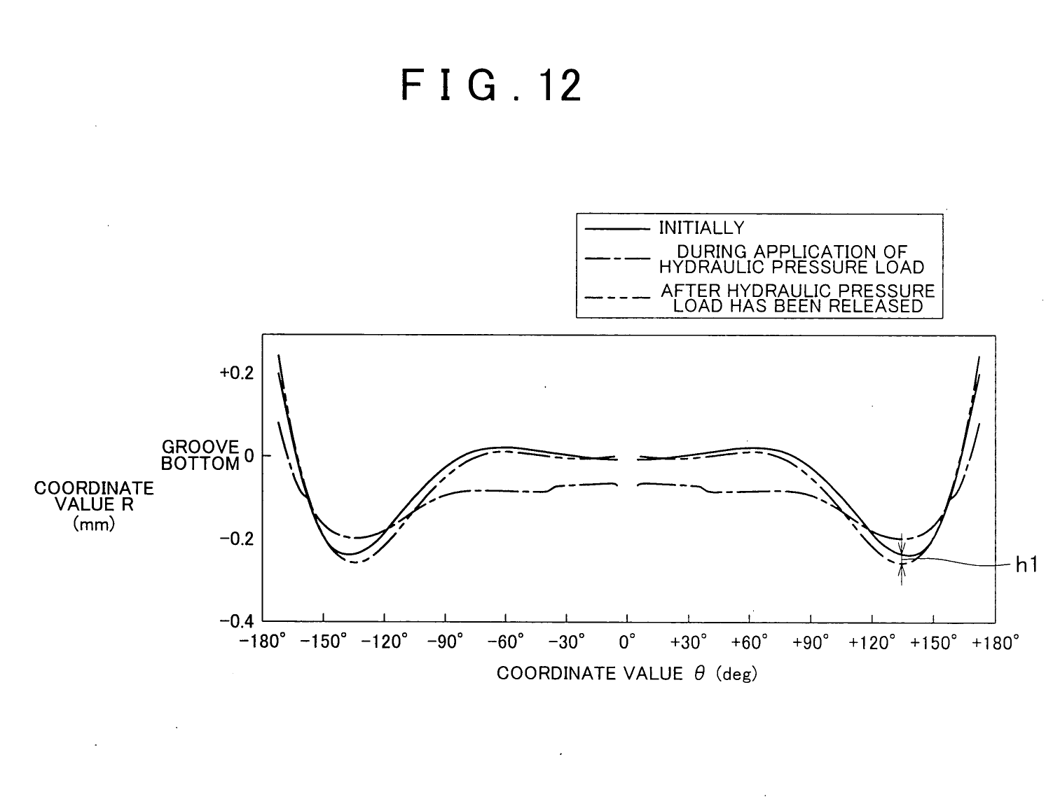

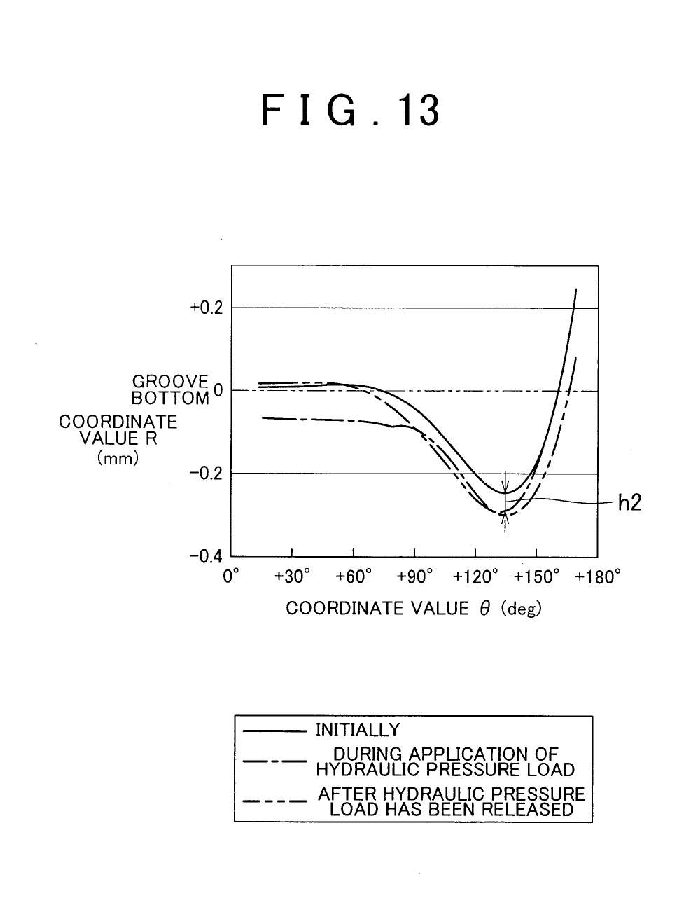

FIG. 12 is a graph showing the relationship between the coordinate value θ and a coordinate value R in the support structure of a brake shown in FIG. 2. FIG. 13 is a graph showing the relationship between the coordinate value θ and the coordinate value R in the support structure of a brake for comparison shown in FIG. 6. In the drawings, the position of the corner portion E is indicated by the coordinate value R. The position where the corner portion E contacts the bottom surface 41d of the groove 41 is R=0, and movement in the rising direction of the corner portion E is expressed as displacement to the negative side.

Referring to FIGS. 12 and 13, the results of the CAE analysis confirmed that the gaps between the outer peripheral surface 31d and the bottom surface 41d were greatest between the ranges of θ=+180° to θ=+90° and θ=−180° to θ=−90°. Also, when looking at the behavior of the snap ring 31 at θ=+135°, the displacement in the rising direction of the corner portion E during a period from a timing when the hydraulic pressure load was applied to a timing when the hydraulic pressure load was released was h2 with the support structure of a brake for comparison shown in FIG. 6. In contrast, with the support structure of a brake shown in FIG. 2, that displacement was h1 which is smaller than h2. Thus, it was confirmed that the support structure of a brake shown in FIG. 2 suppresses movement of the snap ring 31 in the rising direction at the phases where the gaps between the outer peripheral surface 31d and the bottom surface 41d are greatest.

In this example embodiment, the brake 11 described uses the inner diameter fitting snap ring 31 (i.e., the snap ring 31 which fits into an inner diameter groove). Alternatively, however, the invention may also be applied to a brake that uses an outer diameter fitting snap ring (i.e., a snap ring which fits into an outer diameter groove). In this case, the rising direction of the snap ring is the direction from the inner diameter side toward the outer diameter side in the radial direction around the axis around which the groove is formed. Also, the invention is not limited to being applied only to a brake, but may also be applied to a clutch of an automatic transmission. Further, the invention may also be applied to a continuously variable transmission.

The example embodiments disclosed herein are in all respects merely examples and should in no way be construed as limiting. The scope of the invention is indicated not by the foregoing description but by the scope of the claims for patent, and is intended to include all modifications that are within the scope and meanings equivalent to the scope of the claims for patent.

What is claimed is:

1. A support structure of a friction apply device, comprising:
a snap ring arranged in a groove that extends in a circle around a predetermined axis;
a plurality of friction plates arranged side by side in the axial direction, movement of the plurality of friction plates in the axial direction being restricted by the snap ring, and the friction plates engaging together by friction when pushed toward the snap ring;
a plate member arranged between the friction plates and the snap ring; and
a first elastic member and a second elastic member which push the plate member against the snap ring,
wherein the snap ring includes a pair of abutments which face one another across a gap in the circumferential direction; the first elastic member is arranged within a range of +90° with respect to the center of the gap around the axis; and the second elastic member is arranged within a range of −90° with respect to the center of the gap around the axis.

2. The support structure of a friction apply device according to claim 1, wherein the first elastic member is arranged within a range from +30° to +60°, inclusive, with respect to the center of the gap around the axis; and the second elastic member is arranged within a range from −30° to −60°, inclusive, with respect to the center of the gap around the axis.

3. The support structure of a friction apply device according to claim 2, wherein the first elastic member applies pressure to the snap ring at a position of +45° with respect to the center of the gap around the axis; and the second elastic member applies pressure to the snap ring at a position of −45° with respect to the center of the gap around the axis.

4. The support structure of a friction apply device according to claim 1, wherein the first elastic member and the second elastic member are arranged axisymmetrical with respect to a straight line that connects the center of the gap and the center of the snap ring.

5. The support structure of a friction apply device according to claim 1, further comprising:
a third elastic member which is arranged within a range from +150° to +210°, inclusive, with respect to the center of the gap around the axis and applies pressure to the snap ring.

6. The support structure of a friction apply device according to claim 5, wherein the third elastic member is arranged at a position of +180° with respect to the center of the gap around the axis.

7. The support structure of a friction apply device according to claim 5, wherein the first elastic member, the second elastic member, and the third elastic member are arranged at equidistant intervals around a center axis of the snap ring.

8. The support structure of a friction apply device according to claim 1, further comprising:
a piston member which is arranged on the opposite side of the friction plates from the plate member and applies pressure to the friction plates by moving in a direction toward the plate member,
wherein the first elastic member and the second elastic member are arranged between the piston member and the plate member and urge the piston member in a direction away from the plate member.

9. A transmission comprising:
the support structure of a friction apply device according to claim 1.

10. A support structure of a friction apply device, comprising:
a snap ring arranged in a groove that extends in a circle around a predetermined axis;
a plurality of friction plates arranged side by side in the axial direction, movement of the plurality of friction plates in the axial direction being restricted by the snap ring, and the friction plates engaging together by friction when pushed toward the snap ring;
a plate member arranged between the friction plates and the snap ring; and
a first elastic member and a second elastic member which push the plate member against the snap ring,
wherein the snap ring includes a pair of abutments which face one another across a gap in the circumferential direction; a first gap between the snap ring and a bottom surface of the groove is formed adjacent to one of the two abutments, and a second gap between the snap ring and the bottom surface of the groove is formed adjacent to the other of the two abutments; the first elastic member is arranged at a phase where the first gap is greatest around the axis; and the second elastic member is arranged at a phase where the second gap is greatest around the axis.

11. The support structure of a friction apply device according to claim 10, wherein the phase where the first gap is greatest is a position of +45° with respect to the center of the gap around the axis; and the phase where the second gap is greatest is a position of −45° with respect to the center of the gap around the axis.

12. The support structure of a friction apply device according to claim 10, further comprising:
a piston member which is arranged on the opposite side of the friction plates from the plate member and applies pressure to the friction plates by moving in a direction toward the plate member,
wherein the first elastic member and the second elastic member are arranged between the piston member and the plate member and urge the piston member in a direction away from the plate member.

13. A transmission comprising:
the support structure of a friction apply device according to claim 10.
